(19) United States
(12) Patent Application Publication
(10) Pub. No.: US 2024/0002615 A1
(43) Pub. Date: Jan. 4, 2024

(54) POLYIMIDE FILM FOR GRAPHITE SHEET, MANUFACTURING METHOD THEREFOR, AND GRAPHITE SHEET MANUFACTURED THEREFROM

(71) Applicant: PI Advanced Materials Co., Ltd., Chungcheongbuk-do (KR)

(72) Inventors: Jae-Ho MIN, Chungcheongbuk-do (KR); Dong-Young WON, Chungcheongbuk-do (KR)

(21) Appl. No.: 18/254,820

(22) PCT Filed: Nov. 26, 2021
(86) PCT No.: PCT/KR2021/017643

§ 371 Date: May 26, 2023

(30) Foreign Application Priority Data
Nov. 30, 2020 (KR) 10-2020-0164045

(51) Int. Cl. C08J 5/18; C08G 73/10; C08K 3/32; C08K 3/30; C08K 3/26

(52) U.S. Cl. CPC C08J 5/18; C08G 73/1067; C08K 3/32; C08K 3/30; C08K 2201/003; C08K 2003/325; C08K 2003/3045; C08K 2003/265; C08J 2379/08; C08K 3/26

(57) ABSTRACT

Disclosed are a polyimide film for a graphite sheet, the polyimide film having a thickness of 100 μm or larger and a 1%-weight-loss thermal decomposition temperature of 480° C. or lower and/or an L* value of 40 or higher being measured with a colorimeter, a method of forming the same polyimide film, and a graphite sheet manufactured using the same polyimide film.

### TECHNICAL FIELD

The present disclosure relates to a polyimide film for a graphite sheet, a method of forming the same polyimide film, and a graphite sheet manufactured using the same polyimide film. More specifically, the present disclosure relates to a polyimide film for a graphite sheet having excellent surface quality and thermal conductivity and being capable of obtaining high thickness, to a method of forming the same polyimide film, and to a graphite sheet manufactured using the same polyimide film.

### BACKGROUND ART

Recently, electronic devices have become lighter, smaller, thinner, and highly integrated, so a great deal of heat is thus generated in the electronic device. Such heat may shorten the life cycle of products or cause failure or malfunction. Therefore, heat management of electronic devices has emerged as an important issue.

A graphite sheet has a higher thermal conductivity than a metal sheet such as copper, aluminum, or the like, and thus has attracted attention as a heat dissipation member for electronic devices. In particular, research is actively being conducted on high-thickness graphite sheets (for example, graphite sheets having a thickness of about 100 μm or more), which is advantageous in terms of heat capacity compared to thin graphite sheets (for example, graphite sheets having a thickness of about 40 μm or smaller.

Graphite sheets may be manufactured by a variety of methods. For example, a graphite sheet may be manufactured by carbonizing and graphitizing a polymer film. In particular, polyimide films are in the limelight as polymer films for producing graphite sheets due to excellent mechanical and thermal dimensional stability and chemical stability thereof.

A high-thickness graphite sheet can be manufactured by carbonizing and graphitizing a high-thickness polyimide film (for example, a polyimide film having a thickness of about 100 μm or more). However, a good-quality graphite sheet in which the surface is smooth and the internal graphite structure is undamaged is difficult to be obtained, so there is a problem in that the yield is low. This is because, assuming that carbonization and graphitization are performed almost simultaneously on a surface layer and inside the polyimide film, in the case of a high-thickness polyimide film, the amount of sublimation gas generated from the inside is large. As a result, the graphite structure already formed on the surface layer or in the process of being formed is highly likely to be damaged. In addition, a relatively large amount of sublimation gas may cause a large increase in pressure not only on the surface but also in the center portion of the film and the inner area adjacent thereto, which may be seen as one cause of damage to the graphite structure already formed on the surface layer or in the process of being formed.

Therefore, there is a growing need for techniques capable of producing a high-quality graphite sheet having a high thickness as well as intact surface quality and undamaged graphite structure.

### DISCLOSURE

### Technical Problem

An objective of the present disclosure is to provide a polyimide film for a graphite sheet having excellent surface quality and thermal conductivity and being capable of obtaining high thickness.

Another objective of the present disclosure is to provide a method of forming the polyimide film described above.

A further objective of the present disclosure is to provide a graphite sheet manufactured using the polyimide film.

### Technical Solution

1. According to one aspect, a polyimide film for a graphite sheet is provided. The polyimide film may have a thickness of 100 μm or larger and a 1%-weight-loss thermal decomposition temperature of 480° C. or lower being measured by thermogravimetric analysis (TGA).
2. According to another aspect, a polyimide film for a graphite sheet is provided. The polyimide film may have a thickness of 100 μm or larger and an L* value of 40 or higher being measured with a colorimeter.
3. In the first or second embodiment, the polyimide film may include a sublimable inorganic filler.
4. In the third embodiment, the sublimable inorganic filler may have an average particle diameter (D₅₀) in a range of 1 μm to 10 μm. In addition, the sublimable inorganic filler may be included in an amount in a range of 0.15 parts to 0.25 parts by weight per 100 parts by weight of the polyimide film.
5. In the third or fourth embodiment, the sublimable inorganic filler may include dicalcium phosphate, barium sulfate, calcium carbonate, or combinations thereof.
6. According to a further aspect, a method of forming a polyimide film for a graphite sheet is provided. The method may include: preparing a polyamic acid solution by causing a reaction between a diamine monomer and a dianhydride monomer in a solvent; preparing a precursor composition for a polyimide film by adding an imidizing agent, a dehydrating agent, a sublimable inorganic filler, or combinations thereof to the polyamic acid solution; forming a gel film by applying the precursor composition on a support and then drying the same composition; and forming the polyimide film by performing a heat treatment on the gel film.
7. In the sixth embodiment, the diamine monomer may include 4,4′-oxydianiline, 3,4′-oxydianiline, p-phenylenediamine, m-phenylenediamine, 4,4′-methylenedianiline, 3,3′-methylenedianiline, or combinations thereof. In addition, the dianhydride monomer may include pyromellitic dianhydride, 3,3′,4,4′-biphenyltetracarboxylic dianhydride, 2,3,3′,4-biphenyltetracarboxylic dianhydride, oxydiphthalic anhydride, bis(3,4-dicarboxyphenyl)sulfone dianhydride, 3,3′,4,4′-benzophenonetetracarboxylic dianhydride, or combinations thereof.
8. In the sixth or seventh embodiment, the drying of the precursor composition may be performed at a temperature in a range of 30° C. to 200° C. for 15 seconds to 30 minutes.
9. In one of the sixth to eighth embodiments, the heat treatment may be performed at a temperature in a range of 250° C. to 450° C. for 30 seconds to 40 minutes.
10. According to yet a further aspect, a graphite sheet is provided. The graphite sheet is manufactured by carbonizing and graphitizing any one of the polyimide films of the first to fifth embodiments or a polyimide film formed by any one of the formation methods of the sixth to ninth embodiments. The graphite sheet may have a thickness of 100 μm or larger.
11. In the tenth embodiment, the graphite sheet may have a thermal diffusivity of 640 mm²/s or higher.
12. In the tenth or eleventh embodiment, the graphite sheet is the polyimide film in which the graphite sheet has 5 or fewer projections (bright spots) having a long diameter of 0.05 mm or larger per unit area of 50 mm×50 mm.

### Advantageous Effects

The present disclosure can provide a polyimide film for a graphite sheet having excellent surface quality and thermal conductivity and being capable of obtaining high thickness, a method of forming the same polyimide film, and a graphite sheet manufactured using the same polyimide film.

### BEST MODE

As used herein, the singular forms are intended to include the plural forms as well, unless the context clearly indicates otherwise.

It will be further understood that the terms “comprise”, “include”, “have”, etc. when used herein, specify the presence of stated features or components, but do not preclude the presence or addition of one or more other features or components.

Components are interpreted to include an ordinary error range even if not expressly stated.

As used herein to represent a specific numerical range, the expression “a to b” means “≥a and ≤b”.

The inventors of the present disclosure repeatedly conducted intensive research on a polyimide film for a graphite sheet having excellent surface quality and thermal conductivity and being capable of obtaining high thickness. As a result, when manufacturing a graphite sheet using a polyimide film having a thickness of 100 μm or larger and a 1%-weight-loss thermal decomposition temperature of 480° C. or lower measured by thermogravimetric analysis (TGA) and/or having an L* value of 40 or higher measured with a colorimeter, it was found that the time required for carbonization and/or graphitization was able to be shortened. Consequently, it was found that a high-thickness graphite sheet having excellent surface quality and thermal conductivity was able to be manufactured, and thus the present disclosure was completed.

Hereinafter, the present disclosure will be described in further detail.

Polyimide Film for High-Thickness Graphite Sheet

A polyimide film, according to one aspect of the present disclosure, may have a thickness of 100 μm or larger and a 1%-weight-loss thermal decomposition temperature of 480° C. or lower (for example, in a range of 300° C. to 480° C., or for another example, in a range of 400° C. to 480° C.) measured by thermogravimetric analysis. Within the above numerical range, the high-thickness graphite sheet having excellent surface quality and thermal conductivity can be manufactured. In this case, a thermogravimetric analyzer (TGA 5500, purchased from TA Co. Ltd.) may be used to perform thermogravimetric analysis (TGA) for measurement by heating the temperature from room temperature (23° C.) to 1,100° C. at a heating rate of 10° C./min. However, the present disclosure is not limited thereto. For example, the 1%-weight-loss thermal decomposition temperature of the polyimide film being measured by thermogravimetric analysis may be 460° C. or lower, for another example, 450° C. or lower, for a further example, 440° C. or lower, or for yet a further example, 430° C. or lower. Within the above numerical range, it may be further advantageous to manufacture the high-thickness graphite sheet having excellent surface quality and thermal conductivity. However, the present disclosure is not limited thereto.

Another polyimide film, according to another aspect of the present disclosure, may have a thickness of 100 μm or larger and an L* value of 40 or higher being measured with a colorimeter. Within the above numerical range, the high-thickness graphite sheet having excellent surface quality and thermal conductivity may be manufactured. In this case, a colorimeter (UltraScan Pro, purchased from Hunter Lab Co.) may be used to measure the L* value. For example, the L* value of the polyimide film being measured with the colorimeter may be 45 or higher, for another example, 50 or higher, or for a further example, 53 or higher. Within the above numerical range, it may be further advantageous to manufacture the high-thickness graphite sheet having excellent surface quality and thermal conductivity. However, the present disclosure is not limited thereto.

According to one embodiment, the polyimide film may have a thickness in a range of 100 μm to 200 μm (for example, in a range of 100 μm to 170 μm, for another example, in a range of 100 μm to 170 μm, or for a further example, in a range of 100 μm to 150 μm). Within the above numerical range, it may be further advantageous to manufacture the high-thickness graphite sheet having excellent surface quality and thermal conductivity. However, the present disclosure is not limited thereto.

According to one embodiment, the polyimide film may include a sublimable inorganic filler. The “sublimable inorganic filler” may refer to an inorganic filler that sublimes due to heat generated during a carbonization and/or graphitization process when manufacturing the graphite sheet. In the case where the polyimide film includes the sublimable inorganic filler, voids may be formed in the graphite sheet by gas generated through sublimation of the sublimable inorganic filler when manufacturing the graphite sheet. Thus, a sublimation gas generated when manufacturing the graphite sheet is facilitated to be exhausted. As a result, a good-quality graphite sheet can be obtained. In addition, the flexibility of the graphite sheet can be improved, so the handling and moldability of the graphite sheet can be ultimately improved. Examples of the sublimable inorganic filler may include dicalcium phosphate, barium sulfate, calcium carbonate, or combinations thereof, but are not limited thereto. The sublimable inorganic filler may have an average particle diameter (D₅₀) in a range of 1 μm to 10 μm (for example, in a range of 1 μm to 5 μm). Within the above numerical range, it may be advantageous to obtain a good-quality graphite sheet, but the present disclosure is not limited thereto. The sublimable inorganic filler may be included in an amount in a range of 0.15 parts to 0.25 parts by weight (for example, in a range of 0.2 parts to 0.25 parts by weight) based on 100 parts by weight of the polyimide film. Within the above numerical range, a good-quality graphite sheet may be obtained, but the present disclosure is not limited thereto.

The aforementioned polyimide film can be formed without limitation using existing methods known in the field of polyimide film. For example, a polyimide film may be formed by a method including the following steps: preparing a polyamic acid solution by causing a reaction between a diamine monomer and a dianhydride monomer in a solvent; preparing a precursor composition for a polyimide film by adding an imidizing agent, a dehydrating agent, a sublimable inorganic filler, or combinations thereof to the polyamic acid solution; forming a gel film by applying the precursor composition on a support and then drying the same composition; and forming a polyimide film by performing a heat treatment on the gel film.

First, a polyamic acid solution may be prepared by causing a reaction between a diamine monomer and a dianhydride monomer in a solvent.

The solvent is not particularly limited as long as it can dissolve a polyamic acid. For example, the solvent may include an aprotic polar solvent. Examples of the aprotic polar solvent may include an amide solvent including N,N′-dimethylformamide (DMF), N,N′-dimethylacetamide (DMAc), and the like, a phenol-based solvent including p-chlorophenol, o-chlorophenol, and the like, N-methyl-pyrrolidone (NMP), gamma-butyrolactone (GBL), diglyme, and the like, which may be used alone or in combination of two or more. In some cases, the solubility of the polyamic acid may be controlled using an auxiliary solvent, such as toluene, tetrahydrofiran (THF), acetone, methyl ethyl ketone (MEK), methanol, ethanol, water, or the like.

A variety of diamine monomers known in the art may be used as the diamine monomer without limitation within a range that does not impair the objectives of the present disclosure. For example, examples of the diamine monomer may include 4,4′-oxydianiline, 3,4′-oxydianiline, p-phenylenediamine, m-phenylenediamine, 4,4′-methylenedianiline, 3,3′-methylenedianiline, or combinations thereof. In this case, a polyimide film that is advantageous in molecular orientation can be formed, which may be further advantageous to manufacture the graphite sheet having excellent thermal conductivity during carbonization and graphitization.

A variety of dianhydride monomers known in the art may be used as the dianhydride monomer without limitation within a range that does not impair the objectives of the present disclosure. For example, examples of the dianhydride monomer may include pyromellitic dianhydride, 3,3′,4,4′-biphenyltetracarboxylic dianhydride, 2,3,3′,4-biphenyltetracarboxylic dianhydride, oxydiphthalic anhydride, bis(3,4-dicarboxyphenyl)sulfone dianhydride, 3,3′,4,4′-benzophenonetetracarboxylic dianhydride, or combinations thereof. In this case, a polyimide film that is advantageous in molecular orientation can be formed, which may be further advantageous to manufacture the graphite sheet having excellent thermal conductivity during carbonization and graphitization.

The diamine monomer and the dianhydride monomer are included in the solvent so as to be in a substantially equimolar amount. In this case, “substantially equimolar” may mean that the dianhydride monomer is included in an amount in a range of 99.8 mol % to 100.2 mol % based on the total number of moles of the diamine monomer. A method of causing the reaction between the diamine monomer and the dianhydride monomer in substantially equimolar amounts may include, for example,
(a) a method in which all the diamine monomers (or dianhydride monomers) are introduced into the solvent, and the dianhydride monomers (or diamine monomers) are then introduced in a substantially equimolar amount for the reaction,
(b) a method in which a portion of the diamine monomer (or dianhydride monomer) is introduced into the solvent, and the dianhydride monomer (or diamine monomer) is introduced at a ratio in a range of 95 mol % to 105 mol % with respect to the diamine monomer (or dianhydride monomer), followed by introducing the diamine monomer and/or dianhydride monomer to be in a substantially equimolar amount, and
(c) a method in which a first composition is prepared by introducing a portion of the diamine monomer (or dianhydride monomer) and a portion of the dianhydride monomer (or diamine monomer) into the solvent, where one or the other is to be in excess, and a second composition is prepared by introducing a portion of the diamine monomer (or dianhydride monomer) and a portion of the dianhydride monomer (or diamine monomer) into a separate solvent, where one or the other is to be in excess, followed by mixing the first and second compositions for the reaction. In this case, when introducing an excessive amount of the diamine monomer (or dianhydride monomer) into the first composition, an excessive amount of the dianhydride monomer (or diamine monomer) is introduced into the second composition. In (a) to (c), the diamine monomer and the dianhydride monomer may mean one or more (for example, one or two) of the diamine monomers and dianhydride monomers.

According to one embodiment, the polyamic acid may be included in an amount in a range of 5 parts to 35 parts by weight based on 100 parts by weight of the polyamic acid solution. Within the above numerical range, the polyamic acid solution may have a molecular weight and viscosity suitable enough to form the film. Based on 100 parts by weight of the polyamic acid solution, the polyamic acid may be included in an amount, for example, in a range of 5 parts to 30 parts by weight, or for another example, in a range of 10 parts to 25 parts by weight. However, the amount of polyamic acid is not limited thereto.

According to one embodiment, the polyamic acid solution may have a viscosity in a range of 100,000 cP to 500,000 cP at a temperature of 23° C. and a shear rate of 1 s⁻¹. Within the above numerical range, the polyamic acid solution may have a predetermined molecular weight while workability in polyimide film formation may be further good. In this case, the “viscosity” may be measured using a HAAKE Mars Rheometer. At a temperature of 23° C. and a shear rate of 1 s⁻¹, the polyamic acid solution may have a viscosity, for example, in a range of 100,000 cP to 450,000 cP, for another example, in a range of 150,000 cP to 400,000 cP, or for a further example, in a range of 150,000 cP to 350,000 cP. However, the viscosity of the polyamic acid solution is not limited thereto.

According to one embodiment, the polyamic acid may have a weight average molecular weight of 100,000 g/mol to 500,000 g/mol. Within the above numerical range, it may be further advantageous to manufacture the graphite sheet having excellent thermal conductivity. In this case, the “weight average molecular weight” may be measured with gel chromatography (GPC) using polystyrene as a standard sample. The polyamic acid may have a weight average molecular weight, for example, in a range of 100,000 g/mol to 450,000 g/mol, or for another example, in a range of 150,000 g/mol to 400,000 g/mol. However, the weight average molecular weight of the polyamic acid is not limited thereto.

Next, a precursor composition for a polyimide film may be prepared by adding an imidizing agent, a dehydrating agent, a sublimable inorganic filler, or combinations thereof to the polyamic acid solution. Since the description of the sublimable inorganic filler has been described above, a description thereof will be omitted.

The “imidizing agent” is a component responsible for promoting a ring-closure reaction for the polyamic acid. Examples of the imidizing agent may include an aliphatic tertiary amine, an aromatic tertiary amine, a heterocyclic tertiary amine, and the like. Of all these examples, the heterocyclic tertiary amine may be used in terms of the reactivity of a catalyst. Examples of the heterocyclic tertiary amine may include quinoline, isoquinoline, β-picoline, pyridine, and the like, which may be used alone or in combination of two or more. The imidizing agent may be added in an amount in a range of 0.05 moles to 3 moles (for example, in a range of 0.2 moles to 2 moles) based on 1 mole of an amic acid group in the polyamic acid. Within the above numerical range, it may be further advantageous to realize sufficient imidization and to form a film type. However, the present disclosure is not limited thereto.

The “dehydrating agent” is a component responsible for promoting a ring-closure reaction through the dehydration of the polyamic acid. Examples of the dehydration agent may include an aliphatic acid anhydride, an aromatic acid anhydride, N,N′-dialkylcarbodiimides, a lower aliphatic halide, a halogenated lower aliphatic acid anhydride, an arylphosphonic acid dihalide, a thionyl halide, and the like, which may be used alone or in combination of two or more. Of all these examples, the aliphatic acid anhydride, including acetic anhydride, propionic anhydride, lactic acid anhydride, and the like, may be used in terms of availability and cost. The dehydrating agent may be added in an amount in a range of 0.5 moles to 5 moles (for example, in a range of 1 mole to 4 moles) with respect to 1 mole of the amic acid group in the polyamic acid. Within the above numerical range, it may be further advantageous to realize sufficient imidization and to form a film type. However, the present disclosure is not limited thereto.

Thereafter, a gel film is formed by applying the precursor composition on a support and then drying the same composition.

Examples of the support may include a glass plate, aluminum foil, an endless stainless belt, a stainless drum, and the like, but is not limited thereto.

A method of applying the precursor composition is not particularly limited, which may be, for example, a casting method.

For example, the drying of the precursor composition may be performed at a temperature in a range of 30° C. to 200° C. for 15 seconds to 30 minutes. Within the above numerical range, it may be further advantageous to form a predetermined polyimide film intended by the present disclosure. However, the present disclosure is not limited thereto. According to one embodiment, the drying of the precursor composition may be performed at a temperature in a range of 50° C. to 150° C. for 5 minutes to 20 minutes.

In some cases, stretching the gel film may be further included to control the thickness and size of the finally obtained polyimide film and to improve orientation. In addition, the stretching may be performed in at least one of a machine direction (MD) and a transverse direction (TD).

Then, the polyimide film may be formed by performing heat treatment on the gel film.

The heat treatment may be, for example, performed at a temperature in a range of 250° C. to 450° C. for 30 seconds to 40 minutes. Within the above numerical range, it may be further advantageous for a predetermined polyimide film intended by the present disclosure to be formed into a predetermined polyimide film. However, the present disclosure is not limited thereto. The heat treatment may be performed at a temperature, for example, in a range of 250° C. (alternatively, 300° C. or 350° C.) to 430° C., for another example, in a range of 250° C. to 420° C., for a further example, in a range of 250° C. to 410° C., for yet a further example, in a range of 250° C. to 400° C., or for still yet a further example, in a range of 250° C. to 390° C., for, for example, 5 minutes to 30 minutes, for another example, 10 minutes to 30 minutes, or for a further example, 15 minutes to 25 minutes. Within the above numerical range, it may be further advantageous to manufacture the high-thickness graphite sheet having excellent surface quality and thermal conductivity. However, the present disclosure is not limited thereto.

The polyimide film formed by the above-described formation method may be advantageous in implementing a graphite sheet having excellent surface quality and thermal conductivity and capable of obtaining high thickness.

High-Thickness Graphite Sheet

According to a further aspect of the present disclosure, provided is a graphite sheet manufactured by carbonizing and graphitizing the aforementioned polyimide film for the graphite sheet. In this case, the graphite sheet may have a thickness of 100 μm or larger (for example, in a range of 100 μm to 400 μm), thereby having advantageous properties for being used as a heat dissipation means applied to electronic devices.

The “carbonizing” is a process of thermally degrading polymer chains in the polyimide film to manufacture a preliminary graphite sheet including an amorphous carbon body, a non-crystalline carbon body, and/or a shapeless carbon body. The carbonizing may be, for example, performed by heating the polyimide film to a temperature in a range of 1,100° C. to 1,300° C. at a heating rate in a range of 0.3° C./min to 10° C./min. Within the above numerical range, it may be advantageous to manufacture the high-thickness graphite sheet having excellent surface quality and thermal conductivity. However, the present disclosure is not limited thereto. The carbonizing may be performed under reduced pressure or in an inert gas atmosphere. In addition, for high orientation of carbon, a hot press and the like may be selectively used during the carbonizing to apply pressure to the polyimide film. In this case, the pressure may be, for example, 5 kg/cm² or higher, for another example, 15 kg/cm² or higher, or for a further example, 25 kg/cm² or higher. However, the pressure is not limited thereto.

The “graphitizing” is a process of rearranging carbon in the amorphous carbon body, the non-crystalline carbon body, and/or the shapeless carbon body to manufacture the graphite sheet. The graphitizing may be, for example, performed by heating the preliminary graphite sheet to a temperature in a range of 2,500° C. to 3,000° C. at a heating rate in a range of 0.3° C./min to 20° C./min. Within the above numerical range, it may be advantageous to manufacture the high-thickness graphite sheet having excellent surface quality and thermal conductivity. However, the present disclosure is not limited thereto. The graphitizing may be performed under reduced pressure or in an inert gas atmosphere. In addition, for high orientation of carbon, a hot press and the like may be selectively used during the graphitizing to apply pressure to the preliminary graphite sheet. In this case, the pressure may be, for example, 100 kg/cm² or higher, for another example, 200 kg/cm² or higher, or for a further example, 300 kg/cm² or higher. However, the pressure is not limited thereto.

According to one embodiment, the graphite sheet may have a thickness in a range of 100 μm to 300 μm. According to one embodiment, the graphite sheet may have a thickness in a range of 200 μm to 300 μm. Within the above numerical ranges, handling may be excellent, but the thickness of the graphite sheet is not limited thereto.

According to one embodiment, the graphite sheet may have a thermal diffusivity of 640 mm²/s or more. Within the above numerical range, it may be further advantageous for the graphite sheet to be used as a heat dissipation means applied to electronic devices. The graphite sheet may have a thermal diffusivity of, for example, 650 mm²/s or higher for another example, 670 mm²/s or higher, or for a further example, 700 mm²/s or higher. However, the thermal diffusivity of the graphite sheet is not limited thereto.

According to one embodiment, the graphite sheet may have 5 or fewer projections (bright spots) having a long diameter of 0.05 mm or larger per unit area of 50 mm×50 mm. Within the above numerical range, it may be further advantageous for the graphite sheet to be used as a heat dissipation means applied to electronic devices. In the graphite sheet, the number of the generated bright spots per unit area of 50 mm×50 mm may be, for example, 3 or fewer, for another example, 2 or fewer, or for a further example, 1 or fewer. For yet a further example, there may be no bright spots. However, the present disclosure is not limited to this.

### MODE FOR INVENTION

Hereinafter, the present disclosure will be described in further detail with reference to examples. However, these examples are presented as preferred examples of the present disclosure and cannot be construed as limiting the scope of the present disclosure in any sense.

### EXAMPLE

### Example 1

100 g of pyromellitic dianhydride as a dianhydride monomer, 196 g of 4,4′-oxydianiline as a diamine monomer, and 760 g of dimethylformamide as a solvent were mixed and then reacted to prepare a polyamic acid solution having a viscosity of 200,000 cP.

Dicalcium phosphate (average particle diameter (D₅₀): 5 μm) as a sublimable inorganic filler, 14 g of acetic anhydride as a dehydrating agent, 2 g of β-picoline as an imidizing agent, and 10 g of dimethylformamide as a solvent were added to the polyamic acid solution to prepare a precursor composition. In this case, the amount of the sublimable inorganic filler used was set to 2,500 ppm based on the weight of a polyimide film.

The precursor composition was cast on a SUS plate (100SA, purchased from Sandvik Co.) using a doctor blade and then dried at a temperature of 130° C. for 8 minutes to form a gel film. The gel film was separated from the SUS plate, and subjected to heat treatment at a temperature of 380° C. for 20 minutes to form the polyimide film.

### Example 2

A polyimide film was formed in the same manner as in Example 1, except that the temperature of the heat treatment was varied from 380° C. to 400° C.

### Example 3

A polyimide film was formed in the same manner as in Example 1, except that the temperature of the heat treatment was varied from 380° C. to 420° C.

### Comparative Example 1

A polyimide film was formed in the same manner as in Example 1, except that the temperature of the heat treatment was varied from 380° C. to 460° C.

### Evaluation Example

(1) 1%-weight-loss thermal decomposition temperature (Td 1%) (unit: ° C.): A thermogravimetric analyzer (TGA 5500, purchased from TA Co. Ltd.) was used to perform thermogravimetric analysis for measurement by heating the polyimide films formed in Examples and Comparative Example from room temperature (23° C.) to a temperature of 1,100° C. at a heating rate of 10° C./min.
(2) Color L*: The L* value was measured at room temperature using a colorimeter (UltraScan Pro, purchased from Hunter Lab Co.).
(3) Thermal diffusivity (unit: mm²/s): The polyimide films formed in Examples and Comparative Example were carbonized from room temperature to a temperature of 1200° C. at a heating rate of 1° C./min, and then graphitized from the temperature of 1200° C. to a temperature of 2200° C. at a heating rate of 1.5° C./min, from the temperature of 2200° C. to a temperature of 2500° C. at a heating rate of 0.4° C./min, and from the temperature of 2500° C. to a temperature of 2800° C. at a heating rate of 8.5° C./min to manufacture graphite sheets.

Each prepared graphite sheet was cut into a circular shape with a diameter of 25.4 mm to prepare each sample. Then, laser flash analysis was performed on the sample using a thermal diffusivity measuring device (LFA 467, purchased from Netsch Co.) to measure thermal diffusivity.
(4) Bright spots (unit: number): The number of projections having a long diameter of 0.05 mm or larger per unit area of 50 mm×50 mm was measured.

TABLE 1

| | | | | Graphite sheet | | |
|---|---|---|---|---|---|---|
| | Polyimide film | | | Thermal | | |
| | T_{d} 1% | Color L* | Thickness | Diffusivity | Bright Spot | Thickness |
| Example 1 | 427° C. | 55 | 125 μm | 703 mm²/s | 0 | 250 μm |
| Example 2 | 442° C. | 49 | 125 μm | 653 mm²/s | 2 | 263 μm |
| Example 3 | 473° C. | 41 | 125 μm | 642 mm²/s | 3 | 303 μm |
| Comparative | 491° C. | 39 | 125 μm | 636 mm²/s | 10 | 350 μm |
| Example 1 | | | | | | |

Referring to Table 1, the high-thickness graphite sheets manufactured using the polyimide films formed in Examples 1 to 3, in which the 1%-weight-loss thermal decomposition temperature or the L* value falls within the numerical ranges in the present disclosure, have higher thermal diffusivity and fewer bright spots than the high-thickness graphite sheet manufactured using the polyimide film formed in Comparative Example, in which neither the 1%-weight-loss thermal decomposition temperature nor the L* value falls within the numerical ranges in the present disclosure. Thus, it is seen that the high-thickness graphite sheets manufactured using the polyimide films formed in Examples 1 to 3 have excellent thermal conductivity and surface quality.

While exemplary embodiments have been particularly shown and described above, it will be understood by those skilled in the art that various changes in form and details may be made therein without departing from the spirit and scope of the present disclosure as defined by the appended claims. Thus, exemplary embodiments should be considered in a descriptive sense only and not for purposes of limitation. The scope of the present disclosure is defined by the appended claims rather than the detailed description presented above, and all differences within the scope will be construed as being included in the present disclosure.

### INDUSTRIAL APPLICABILITY

The present disclosure can provide a polyimide film for a graphite sheet having excellent surface quality and thermal conductivity and being capable of obtaining high thickness, a method of forming the same polyimide film, and a graphite sheet manufactured using the same polyimide film.

1. A polyimide film for a graphite sheet, the polyimide film having a thickness of 100 μm or larger and a 1%-weight-loss thermal decomposition temperature of 480° C. or lower being measured by thermogravimetric analysis (TGA).

2. A polyimide film for a graphite sheet, the polyimide film having a thickness of 100 μm or larger and an L* value of 40 or higher being measured with a colorimeter.

3. The film of claim 1, wherein the polyimide film comprises a sublimable inorganic filler.

4. The film of claim 3, wherein:
the sublimable inorganic filler has an average particle diameter (D₅₀) in a range of 1 μm to 10 μm; and
the sublimable inorganic filler is comprised in an amount in a range of 0.15 parts to 0.25 parts by weight per 100 parts by weight of the polyimide film.

5. The film of claim 3, wherein the sublimable inorganic filler comprises dicalcium phosphate, barium sulfate, calcium carbonate, or combinations thereof.

6. A method of forming the polyimide film for the graphite sheet of claim 1, the method comprising:
preparing a polyamic acid solution by causing a reaction between a diamine monomer and a dianhydride monomer in a solvent;
preparing a precursor composition for a polyimide film by adding an imidizing agent, a dehydrating agent, a sublimable inorganic filler, or combinations thereof to the polyamic acid solution;
forming a gel film by applying the precursor composition on a support and then drying the same composition; and
forming the polyimide film by performing a heat treatment on the gel film.

7. The method of claim 6, wherein the diamine monomer comprises 4,4′-oxydianiline, 3,4′-oxydianiline, p-phenylenediamine, m-phenylenediamine, 4,4′-methylenedianiline, 3,3′-methylenedianiline, or combinations thereof, and the dianhydride monomer comprises pyromellitic dianhydride, 3,3′,4,4′-biphenyltetracarboxylic dianhydride, 2,3,3′,4-biphenyltetracarboxylic dianhydride, oxydiphthalic anhydride, bis(3,4-dicarboxyphenyl)sulfone dianhydride, 3,3′,4,4′-benzophenonetetracarboxylic dianhydride, or combinations thereof.

8. The method of claim 6, wherein the drying of the precursor composition is performed at a temperature in a range of 30° C. to 200° C. for 15 seconds to 30 minutes.

9. The method of claim 6, wherein the heat treatment is performed at a temperature in a range of 250° C. to 450° C. for 30 seconds to 40 minutes.

10. (canceled)

11. (canceled)

12. (canceled)

13. A method of forming the polyimide film for the graphite sheet of claim 2, the method comprising:
preparing a polyamic acid solution by causing a reaction between a diamine monomer and a dianhydride monomer in a solvent;
preparing a precursor composition for a polyimide film by adding an imidizing agent, a dehydrating agent, a sublimable inorganic filler, or combinations thereof to the polyamic acid solution;
forming a gel film by applying the precursor composition on a support and then drying the same composition; and
forming the polyimide film by performing a heat treatment on the gel film.

14. The method of claim 13, wherein the diamine monomer comprises 4,4′-oxydianiline, 3,4′-oxydianiline, p-phenylenediamine, m-phenylenediamine, 4,4′-methylenedianiline, 3,3′-methylenedianiline, or combinations thereof, and the dianhydride monomer comprises pyromellitic dianhydride, 3,3′,4,4′-biphenyltetracarboxylic dianhydride, 2,3,3′,4-biphenyltetracarboxylic dianhydride, oxydiphthalic anhydride, bis(3,4-dicarboxyphenyl)sulfone dianhydride, 3,3′,4,4′-benzophenonetetracarboxylic dianhydride, or combinations thereof.

15. The method of claim 13, wherein the drying of the precursor composition is performed at a temperature in a range of 30° C. to 200° C. for 15 seconds to 30 minutes.

16. The method of claim 13, wherein the heat treatment is performed at a temperature in a range of 250° C. to 450° C. for 30 seconds to 40 minutes.

17. The film of claim 2, wherein the polyimide film comprises a sublimable inorganic filler.

18. The film of claim 17, wherein:
the sublimable inorganic filler has an average particle diameter (D₅₀) in a range of 1 μm to 10 μm; and
the sublimable inorganic filler is comprised in an amount in a range of 0.15 parts to 0.25 parts by weight per 100 parts by weight of the polyimide film.

19. The film of claim 17, wherein the sublimable inorganic filler comprises dicalcium phosphate, barium sulfate, calcium carbonate, or combinations thereof.
